(19) United States
(12) Patent Application Publication
(10) Pub. No.: US 2015/0255872 A1
(43) Pub. Date: Sep. 10, 2015

(54) Antenna Device, Transmitter Module Using the Antenna Device, and Location Identifying System Using the Transmitter Module

(71) Applicant: Hosiden Corporation, Osaka (JP)

(72) Inventors: Takao Hasumuro, Osaka (JP); Shunji Muraoka, Osaka (JP); Hirofumi Inoue, Osaka (JP); Hiroki Hatsuda, Osaka (JP)

(21) Appl. No.: 14/630,008

(22) Filed: Feb. 24, 2015

(30) Foreign Application Priority Data
Mar. 6, 2014 (JP) 2014-044065

(51) Int. Cl. H01Q 9/04; H04W 4/02; H04W 4/16

(52) U.S. Cl. CPC H01Q 9/0407; H04W 4/16; H04W 4/02

(57) ABSTRACT

Provided is an antenna device which is compact and light-weight. The antenna device includes a grounded conductor portion formed of a grounded conductor, a base portion including a grounded portion connected to the grounded conductor portion and a power supplied portion receiving input of an AC power, the base portion being made of conductor and disposed in opposition to the grounded conductor portion with a predetermined distance therefrom, a first extension portion extending from an end portion of the base portion where the power supplied portion is formed, the first extension portion having a length as determined from the power supplied portion which length is set according to a frequency of a transmitted/received signal, and a second extension portion extending from a further end portion of the base portion where the grounded portion is formed, the second extension portion having an opposing portion disposed in opposition to a leading end portion of the first extension portion with a predetermined distance therefrom.

### CROSS REFERENCE TO RELATED APPLICATIONS

This application is based on and claims priority under 35 U.S. C. Section 119 to Japanese Patent Application No. 2014-044065 filed on Mar. 6, 2014, the entire content of which is incorporated herein by reference.

### TECHNICAL FIELD

This disclosure relates to an antenna device which is compact and light-weight, a transmitter module using this antenna device and relates also to a location identifying system using this transmitter module.

### RELATED ART

Conventionally, in a hospital, an institution, etc., in order to ensure safety and security for patients or inhabitants thereof, it has been implemented to grasp their life patterns. As a technique for use in such case, there is one disclosed in JP2010-66037A for example. According to a whereabouts detecting system disclosed in JP2010-66037A, from an IC tag attached to a user, an ID (identification) signal of this user is wirelessly transmitted by predetermined time intervals and the ID signal transmitted by the IC tag is received by a plurality of receiver antennas. Based on the ID signal received respectively by the multiple receiver antennas, a server determines a location of the IC tag.

### SUMMARY

In the art disclosed in JP2010-66037A, a user is provided with an IC tag for transmitting an ID signal of this user. For this reason, the IC tag is provided with an antenna. In view of the user's life, it is desired that the antenna be compact and of high sensitivity. However, JP2010-66037A lacks any description to the effect that its antenna is designed with consideration to its compactness and high sensitivity.

Embodiments of the present invention provide an antenna device which is compact and light-weight, a transmitter module using this antenna device and relate also to a location identifying system using this transmitter module.

According to one embodiment of an antenna device relating to this disclosure, the antenna device comprises:

a grounded conductor portion formed of a grounded conductor;

a base portion including a grounded portion connected to the grounded conductor portion and a power supplied portion receiving input of an AC power, the base portion being made of conductor and disposed in opposition to the grounded conductor portion with a predetermined distance therefrom;

a first extension portion extending from an end portion of the base portion where the power supplied portion is formed, the first extension portion having a length as determined from the power supplied portion which length is set according to a frequency of a transmitted/received signal; and

a second extension portion extending from a further end portion of the base portion where the grounded portion is formed, the second extension portion having an opposing portion disposed in opposition to a leading end portion of the first extension portion with a predetermined distance therefrom.

In this case, the leading end portion of the first extension portion and the opposing portion of the second extension portion are placed in opposition to each other and in close vicinity from each other. Therefore, an antenna wire comprised of the first extension portion and the second extension portion can be formed compact. As a result, the antenna device can be formed compact as well. Further, as the lading end portion of the first extension portion and the opposing portion of the second extension portion together form an electrostatic capacitive coupling, the impedance of the antenna wire can be readily set to a desired value by adjustment of the distance between the leading end portion and the opposing portion. Consequently, an antenna device having high sensitivity can be realized.

According to one preferred embodiment of the antenna device, the first extension portion includes a plurality of conductor portions which are connected to each other via an inductor. In this case, the impedance of the antenna wire can be adjusted via the inductor. Thus, the frequency characteristics of the antenna device can readily be set to desired characteristics. Accordingly, an antenna device having high sensitivity can be easily realized.

According to a further preferred embodiment of the antenna device, a forming layer on which the base portion is formed and a grounding layer connected to the grounded conductor portion are formed with using a printed wiring board made of different layers, and a portion where the base portion and the grounding layer are overlapped with each other exists as the printed wiring board is seen along its board thickness direction. In this case, an electrostatic capacitive coupling can be formed by the base portion and the grounding layer. Therefore, the impedance of the antenna wire can be set via this electrostatic capacitive coupling. Thus, the frequency characteristics of the antenna device can readily be set to desired characteristics.

According to a still further preferred embodiment of the antenna device, the first extension portion has a comb-like shape. In this case, while the first extension portion realizes an antenna length, the comb-like shape allows the area occupied by the first extension portion to be compact. Therefore, the antenna device can be readily formed compact.

According to a still further preferred embodiment of the present invention, the impedance of the antenna wire is set according to a distance between the base portion and the grounded conductor portion. In this case, through adjustment of the distance between the base portion and the grounded conductor portion, it is possible to improve the frequency characteristics of the antenna device. Therefore, an antenna device having high sensitivity can be realized.

According to a still further preferred embodiment of the present invention, the second extension portion is disposed parallel with the leading end portion of the first extension portion; and the impedance of the antenna wire is set according to a distance between this second extension portion and the leading end portion. In this case, a predetermined electrostatic capacitive coupling can be readily formed by the second extension portion and the first extension portion. Thus, the impedance of the antenna wire can be adjusted based on this electrostatic capacitive coupling, so that the frequency characteristics of the antenna device can be improved. Therefore, an antenna device high high sensitivity can be realized.

According to a still further preferred embodiment of the present invention, the impedance of the antenna wire is set according to an area of the base portion. In this case, through adjustment of the area of the base portion, the frequency characteristics of the antenna device can be improved. Therefore, an antenna device having high high sensitivity can be realized.

According to one embodiment of a transmitter module relating also to this disclosure, the transmitter module comprises:

a storage section storing ID information capable of identifying a person;

a remaining amount information acquiring section acquiring remaining amount information indicative of a remaining power stored in a battery;

a signal generating section generating a transmission signal based on the ID information and the remaining amount information; and

the antenna device configured to radio-propagate the generated transmission signal.

In this case, as the compact antenna device can be attached to a person, it is possible to reduce the nuisance for the person. Further, without the person's awareness, the ID information of this person can be transmitted. Moreover, since the transmission signal includes remaining amount information indicative of a remaining power stored in a battery employed for driving the transmitter module, it is possible to prompt charging or replacement of the battery when the remaining power is small by transmitting the signal to the surrounding in advance.

According to one embodiment of a location identifying system relating also to this disclosure, the location identifying system comprises:

the transmitter module;

a receiver module receiving a transmission signal from the transmitter module; and

an identifying section identifying a location of the transmitter module based on the received transmission signal.

In this case, as the compact antenna device can be attached to a person, it is possible to reduce the nuisance for the person. Further, without the person's awareness, the location of the person can be readily grasped.

### BRIEF DESCRIPTION OF THE DRAWINGS

FIG. 1 is a view showing a printed wiring board forming an antenna device relating to an embodiment,

FIG. 2 is a view showing respective conductor layers of the printed wiring board,

FIG. 3 is a diagram showing configuration of a transmitter module using the antenna device, and

FIG. 4 is a diagram showing configuration of a location identifying system using the transmitter module.

### DESCRIPTION OF EMBODIMENTS

### 1. Antenna Device

An antenna device relating to this disclosure is comprised of a so-called inverted-F antenna which is formed compact and with high sensitivity. Next, an antenna device 1 relating to this embodiment will be described.

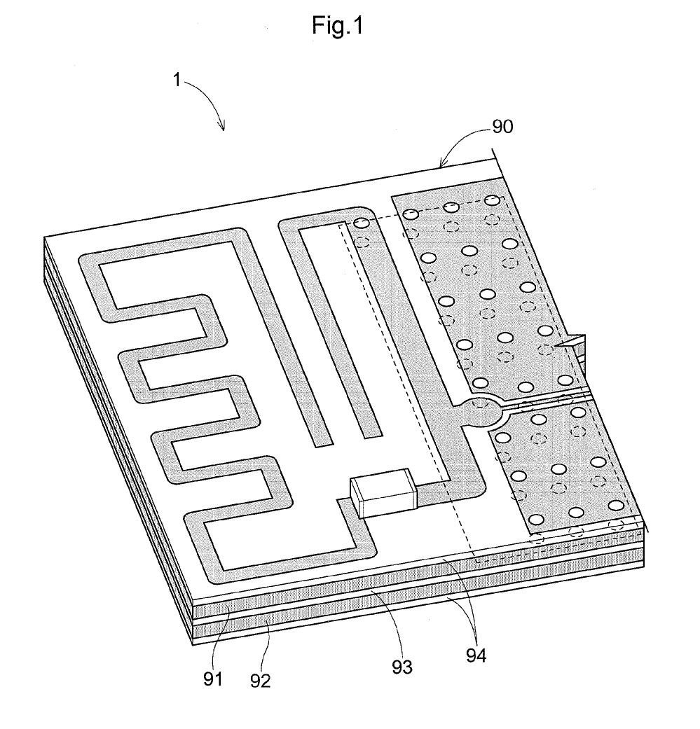

As shown in FIG. 1, in this embodiment, the antenna device 1 is constructed with using a printed wiring board 90 having conductor layers 91, 92 which are made of two different layers. Between the conductor layer 91 and the conductor layer 92, there is provided an insulation layer 93 for insulating the layers 91, 92 from each other. The respective surfaces of the conductor layers 91, 92 are coated with resist 94.

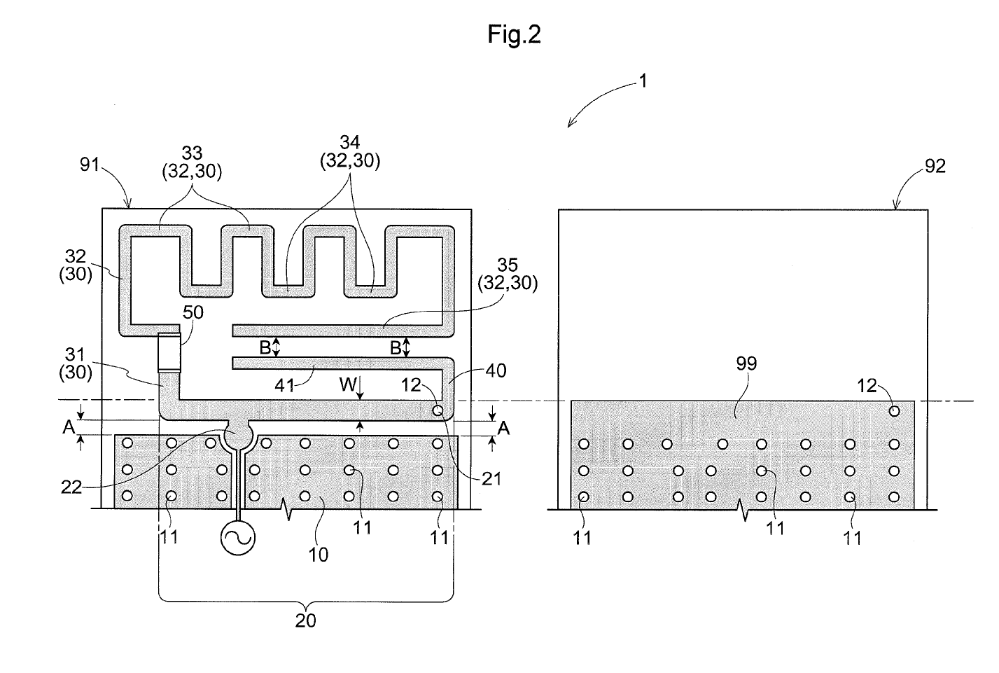

On the left side in FIG. 2, the top face of the conductor layer 91 is shown. On the right side in FIG. 2, the top face of the conductor layer 92 is shown. The antenna device 1 includes a grounded conductor portion 10, a base portion 20, a first extension portion 30 and a second extension portion 40. These portions, i.e. the grounded conductor portion 10, the base portion 20, the first extension portion 30 and the second extension portion 40, are formed by patterning of the conductor layer 91. For this reason, in the context of this disclosure, the conductor layer 91 corresponds to what is defined herein as “a forming layer”. Therefore, the grounded conductor portion 10, the base portion 20, the first extension portion 30 and the second extension portion 40 are formed of conductor. On the other hand, on the conductor layer 92, a grounded portion 99 is formed by patterning of conductor and this grounded portion 99 is used as ground of an antenna. For this reason, in the context of this disclosure, the conductor layer 92 corresponds to what is defined herein as “a grounding layer”. In the description to follow, for readiness of understanding, the “forming layer” will be referred to with addition thereto of a reference numeral 91, and the “grounding layer” will be referred to with addition thereto of a reference numeral 92.

The grounded conductor portion 10 is formed of grounded conductor. Therefore, this grounded conductor portion 10 corresponds to a grounded face as an antenna. This grounded conductor portion 10 is formed on the forming layer 91 of the printed wiring board 90 and is connected to the grounded portion 99 via through holes 11.

The base portion 20 includes a grounded portion 21 and a power supplied portion 22 and is comprised of conductor disposed in opposition to the grounded conductor portion 10 with a predetermined distance (A) therefrom. The grounded portion 21 is connected to the grounded conductor portion 10. In the instant embodiment, the grounded portion 21 is connected to the grounded portion 99 of the grounding layer 92 via a through hole 12. Accordingly, the grounded portion 21 and the grounded conductor portion 10 are connected to each other via the grounded portion 99. The power supplied portion 22 receives input of AC power. This AC power refers to power supplied to the antenna device 1 for causing it to function as an “antenna”. In the instant embodiment, the base portion 20 is formed elongate, as shown in FIG. 2. In this elongate base portion 20, the grounded portion 21 is provided on one end side thereof and the power supplied portion 22 is provided on the other end side thereof, respectively.

The base portion 20 is arranged such that the long side of its elongate shape is placed in opposition to the grounded conductor portion 10 with a predetermined distance (A) therefrom. According to this distance (A) between the base portion 20 and the grounded conductor portion 10, an impedance of the antenna wire is set. With this, an electrostatic capacitive coupling is formed between the base portion 20 and the grounded conductor portion 10. As an electrostatic capacitance due to this electrostatic capacitive coupling varies in inverse proportion to the distance (A), the impedance of the antenna wire can be set according to this distance (A).

Further, the base portion 20 is configured such that this portion includes a portion where this base portion 20 and the grounding layer 92 are overlapped with each other when the printed wiring board 90 is seen in the direction of its board thickness. The language: “seeing the printed wiring board 90 along the board thickness direction” means seeing the printed wiring board 90 from perpendicularly upper side thereof. The base portion 20 is formed such that the grounded portion 99 is present on the layer below the base portion 20, when the printed wiring board 90 is seen from its perpendicularly upper side thereof. With this, electrostatic capacitive coupling is formed between the base portion 20 and the grounded portion 99. As the electrostatic capacitance due to this electrostatic capacitive coupling varies in inverse proportion to the distance between the base portion 20 and the grounded portion 99, the impedance of the antenna wire can be set according to this distance between the base portion 20 and the grounded portion 99.

Alternatively, the impedance of the antenna wire can be set according to the area of the base portion 20. As known, an electrostatic capacitance varies in proportion to an area. For this reason, through adjustment of the area of the base portion 20 by varying a width (W) of the base portion 20, the impedance of the antenna wire can be set as desired.

The first extension portion 30 extends from the end of the base 20 on the side where the power supplied portion 22 is formed and has a length as determined from the power supplied portion 22 which length is set according to a frequency of a transmitted/received signal. Here, the end of the base 20 on the side where the power supplied portion 22 is formed refers to the other end of the elongate base portion 20 described above. The first extension portion 30 is provided to extend with a predetermined width from this end. The length of the first extension portion 30 corresponds to the so-called antenna length of an antenna and this is set as “lambda/4” based on a wavelength lambda of the signal transmitted from/received by the antenna device 1.

In the instant embodiment, the first extension portion 30 includes a plurality of conductor portions. In this embodiment, specifically, the first extension portion 30 includes a root side first extension portion 31 near the side of the base 20 and a leading end side first extension portion 32 on the side of the leading end. And, these multiple conductor portions are connected to each other via an inductor 50. The inductor 50 can be readily board-mounted if e.g. a chip inductor is employed as this inductor 50. With this, the impedance of the antenna wire can be set to a desired value.

Further, the first extension portion 30 has a comb-like shape. Here, the term “comb-like shape” means a shape including convex portions 33 and concave portions 34 in repeated alternation. In the instant embodiment, the convex portions 33 and the concave portions 34 are formed along the direction perpendicular to the extending direction of the root side first extension portion 31. In this embodiment, the leading end side first extension portion 32 comprises such comb-like shape having the convex portions 33 and the concave portions 34.

The first extension portion 30 is formed such that a leading end portion 35 on the more leading end side than the comb-like shape extends parallel with the above-described perpendicular direction along which the convex portions 33 and the concave portions 34 are formed. In particular, in order to form the antenna line compact, in the leading end portion 35, the leading end side first extension portion 32 is formed annular. Therefore, the leading end portion 35 is formed to extend on the root side of the leading end side first extension portion 32.

The second extension portion 40 is formed to extend from the end of the base portion 20 where the grounded portion 21 is formed and includes an opposing portion 41 which is in opposition to the leading end portion 35 of the first extension portion 30 with a predetermined distance (B) therefrom. Here, the end of the base portion 20 on the side where the grounded portion 21 is formed means the one end of the elongate base portion 20 described above. In the instant embodiment, it extends from the above end with a predetermined width along the direction perpendicular to the elongate direction of the base portion 20 and in opposition to and parallel with the leading end portion 35 with the distance (B) from this leading end portion 35. With this, an electrostatic capacitive coupling is established between the leading end portion 35 and the opposing portion 41 and through adjustment of the distance (B) between the leading end portion 35 and the opposing portion 41, the impedance of the antenna wire can be set to a desired value.

In this way, the antenna device 1 can be formed compact. Further, as adjustments of the distances and areas of the various parts are possible, sensitivity adjustment can be made easily. Therefore, the antenna device 1 which is compact and has high sensitivity can be realized.

### 2. Transmitter Module

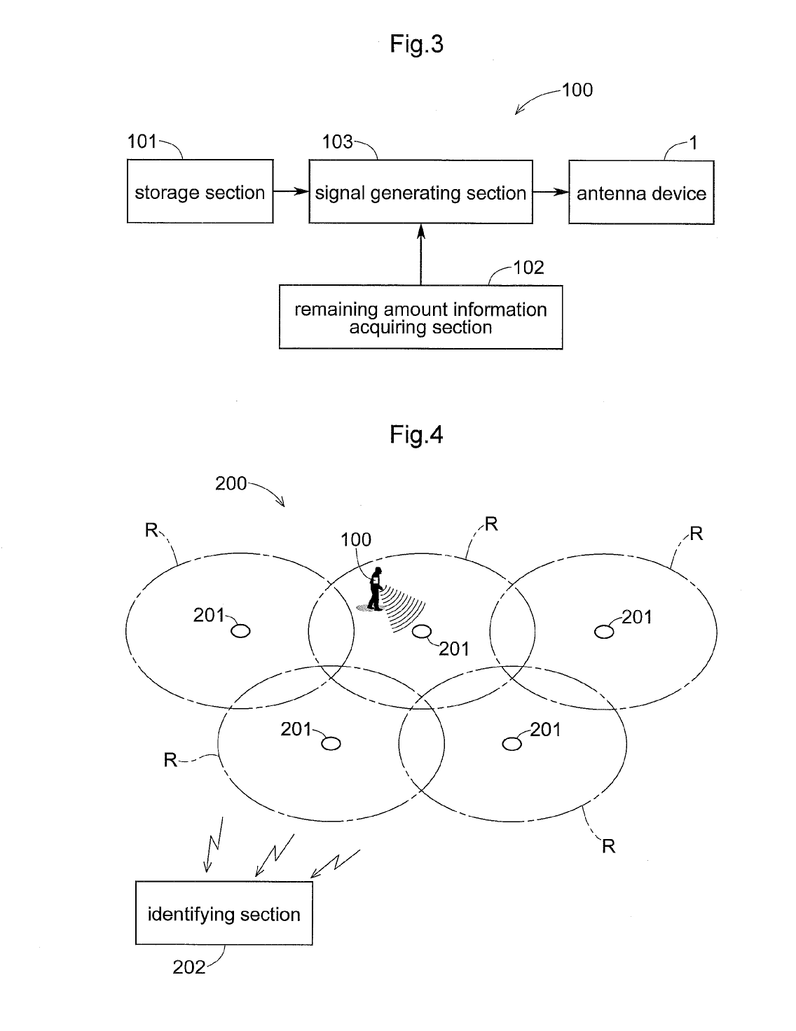

Next, a transmitter module relating also to the present disclosure will be explained. The transmitter module is configured to be attached to a person and to transmit an ID (identification) signal of this person to the surrounding. Next, there will be explained a transmitter module 100 according to the instant embodiment. FIG. 3 shows a block diagram showing a configuration of the transmitter module 100 relating to this embodiment. As shown in FIG. 3, the transmitter module 100 includes a storage section 101, a remaining amount information acquiring section 102, a signal generating section 103, and the antenna device 1.

The storage section 101 stores therein information allowing identification of person. Here, a “person” means a person to which the transmitter module 100 is attached. Also, the “information allowing identification of persons” can be information indicating only presence of a person or a serial number assigned to each person, or can be combination of both of these or any other information. Such ID information are stored in the storage section 101 in advance. The ID information stored in the storage section 101 are read by the signal generating section 103 to be described later.

The remaining amount information acquiring section 102 acquires remaining amount information indicating an amount of power charged and stored in a battery. Here, the battery refers to a battery which stores an amount of power to be supplied to the respective functional components of the transmitter module 100. This battery can be a rechargeable type or a non-rechargeable type. The remaining amount of power stored in such battery can be detected via e.g. a used period, an output voltage, etc. and the remaining amount information acquiring section 102 acquires such remaining amount as the remaining amount information. This remaining amount information is transmitted to the signal generating section 103 to be described next.

The signal generating section 103 generates a transmission signal based on the ID information and the remaining amount information. Here, the transmission signal based on the ID information and the remaining amount information means a signal via which the ID information stored in advance in the storage section 101 and the remaining amount information acquired by the remaining amount information acquiring section 102 are to be transmitted from the transmitter module 100 to the surrounding. More particularly, such signal will be generated by superimposing a signal having predetermined frequency with the ID information and the remaining amount information. The transmission signal generated by the signal generating section 103 is transmitted to the antenna device 1 which will be described next.

The antenna device 1 is configured to radio-propagate the generated transmission signal. As this antenna device 1, there is employed the above-described antenna device which is formed compact and has high sensitivity. The configuration thereof has been described above already. Therefore, further explanation thereof will be omitted. In this way, the transmitter module 100 effects radio propagation of a transmission signal which has been generated from the ID information allowing identification of a person and generated also from the remaining amount information indicative of the remaining amount of power stored in the battery.

### 3. Location Identifying System

Next, a location identifying system relating also to the present disclosure will be explained. The location identifying system is configured to identify a location of a person within a predetermined facility or institution. Next, there will be explained a location identifying system 200 according to the instant embodiment. FIG. 4 shows a block diagram showing a configuration of the location identifying system 200 relating to the instant embodiment. As shown in FIG. 4, the location identifying system 200 includes the transmitter module 100, a receiver module 201, and an identifying section 202. The transmitter module 100 has already been described above, so further explanation thereof will be omitted here.

The receiver module 201 receives the transmission signal from the transmitter module 100. As shown in FIG. 4, the receiver module 201 is provided with a predetermined reception area R which is set according to an output. The receiver module 201, as shown in FIG. 4, can be provided in plurality such that their reception areas R are overlapped with each other. When a transmitter module 100 enters any one of such reception areas R, a transmission signal transmitted from this transmitter module 100 is received by the predetermined receiver module 201. Then, upon reception of the transmission signal, the receiver module 201 transmits this received transmission signal and its intensity to the identifying section 202 to be described next. This transmission from the receiver module 201 to the identifying section 202 can be implemented in either wired manner or a wireless, i.e. radio manner.

The identifying section 202 identifies the location of the transmitter module 100 based on the received transmission signal. To the identifying section 202, the transmission signal and its intensity are transmitted from the receiver module 201. Then, based on the ID information included in the transmission signal, the identifying section 202 identifies the person to which the transmitter module 100 is attached and then calculates a distance from the receiver module 201 to the transmitter module 100, with using the intensity included in the transmission signal. Therefore, through analysis of the transmission signal, the identifying section 202 is capable of identifying the location of the particular person to which the transmitter module 100 is attached and identifying also who this person is. Such identifying section 202 is included in a host provided separately of the receiver module 201.

Such location identifying system 200 as above will be installed in a home for aged people, a hospital, etc. and the transmitter module 100 will be attached to a terminal device of a patient. With this, a situation of a patient entering or existing a room, a whereabouts of a patient, etc. can be readily grasped by a managing person. In such embodiment as above, it will be convenient if the host equipped with the above-described identifying section 202 is provided as a managing terminal for management of patients.

### 4. Other Embodiments

In the foregoing embodiment, it was explained that the antenna device 1 comprises the printed wiring board 90 having two layers of conductor portions. Instead, the antenna device 1 can be comprised of a printed wiring board 90 having one layer of conductor portion. Further alternatively, the device 1 can be configured without using any printed wiring board 90 at all.

In the foregoing embodiment, it was explained that the first extension portion 30 is comprised of two conductor portions consisting of the root side first extension portion 31 and the leading end side first extension portion 32. Instead, the first extension portion 30 can be comprised of three or more conductor portions or of one conductor portion alone.

In the foregoing embodiment, it was explained that when the printed wiring board 90 is seen along its board thickness direction, there exists a portion where the base portion 20 and the grounded portion 99 of the grounding layer 92 are overlapped with each other. Instead, it is also possible to configure such that the base portion 20 and the grounded portion 99 are not overlapped with each other as seen along the board thickness direction.

In the foregoing embodiment, it was explained that the first extension portion 30 has a comb-like shape. Instead, it is also possible for the first extension portion 30 not to have such comb-like shape.

In the foregoing embodiment, it was explained that an electrostatic capacitive coupling is formed between the base portion 20 and the grounded conductor portion 10 and the impedance of the antenna wire is set according to the distance (A) between the base portion 20 and the grounded conductor portion 10. Instead, it is also possible to configure such that no electrostatic capacitive coupling is formed between the base portion 20 and the grounded conductor portion 10.

In the foregoing embodiment, it was explained that the second extension portion 40 is provided to be parallel with the leading end portion 35 of the first extension portion 30 and the impedance of the antenna wire is set according to the distance (B) between this second extension portion 40 and the leading end portion 35. Instead, it is also possible to configure such that the second extension portion 40 and the leading end portion 35 of the first extension portion 30 extend non-parallel to each other or such that no electrostatic capacitive coupling is formed between the second extension portion 40 and the leading end portion 35 of the first extension portion 30.

In the foregoing embodiment, it was explained that the antenna device 1 effects radio (wireless) propagation of transmission signals. Instead, the antenna device 1 can be configured to receive the transmission signals.

This disclosure is applicable to an antenna device which is compact and light-weight, a transmitter module using such antenna device as well as to a location identifying system using such transmitter module.

1. An antenna device comprising:
a grounded conductor portion formed of a grounded conductor;
a base portion including a grounded portion connected to the grounded conductor portion and a power supplied portion receiving input of an AC power, the base portion being made of conductor and disposed in opposition to the grounded conductor portion with a predetermined distance therefrom;
a first extension portion extending from an end portion of the base portion where the power supplied portion is formed, the first extension portion having a length as determined from the power supplied portion which length is set according to a frequency of a transmitted/received signal; and
a second extension portion extending from a further end portion of the base portion where the grounded portion is formed, the second extension portion having an opposing portion disposed in opposition to a leading end portion of the first extension portion with a predetermined distance therefrom.

2. The antenna device according to claim 1, wherein the first extension portion includes a plurality of conductor portions which are connected to each other via an inductor.

3. The antenna device according to claim 1, wherein:
a forming layer on which the base portion is formed and a grounding layer connected to the grounded conductor portion are formed with using a printed wiring board made of different layers; and
a portion where the base portion and the grounding layer are overlapped with each other exists as the printed wiring board is seen along its board thickness direction.

4. The antenna device according to claim 2, wherein:
a forming layer on which the base portion is formed and a grounding layer connected to the grounded conductor portion are formed with using a printed wiring board made of different layers; and
a portion where the base portion and the grounding layer are overlapped with each other exists as the printed wiring board is seen along its board thickness direction.

5. The antenna device according to claim 1, wherein the first extension portion has a comb-like shape.

6. The antenna device according to claim 2, wherein the first extension portion has a comb-like shape.

7. The antenna device according to claim 3, wherein the first extension portion has a comb-like shape.

8. The antenna device according to claim 4, wherein the first extension portion has a comb-like shape.

9. The antenna device according to claim 1, wherein the impedance of the antenna wire is set according to a distance between the base portion and the grounded conductor portion.

10. The antenna device according to claim 2, wherein the impedance of the antenna wire is set according to a distance between the base portion and the grounded conductor portion.

11. The antenna device according to claim 3, wherein the impedance of the antenna wire is set according to a distance between the base portion and the grounded conductor portion.

12. The antenna device according to claim 4, wherein the impedance of the antenna wire is set according to a distance between the base portion and the grounded conductor portion.

13. The antenna device according to claim 1, wherein:
the second extension portion is disposed parallel with the leading end portion of the first extension portion; and
the impedance of the antenna wire is set according to a distance between this second extension portion and the leading end portion.

14. The antenna device according to claim 2, wherein:
the second extension portion is disposed parallel with the leading end portion of the first extension portion; and
the impedance of the antenna wire is set according to a distance between this second extension portion and the leading end portion.

15. The antenna device according to claim 3, wherein:
the second extension portion is disposed parallel with the leading end portion of the first extension portion; and
the impedance of the antenna wire is set according to a distance between this second extension portion and the leading end portion.

16. The antenna device according to claim 1, wherein the impedance of the antenna wire is set according to an area of the base portion.

17. The antenna device according to claim 2, wherein the impedance of the antenna wire is set according to an area of the base portion.

18. The antenna device according to claim 3, wherein the impedance of the antenna wire is set according to an area of the base portion.

19. A transmitter module comprising:
a storage section storing ID information capable of identifying a person;
a remaining amount information acquiring section acquiring remaining amount information indicative of a remaining power stored in a battery;
a signal generating section generating a transmission signal based on the ID information and the remaining amount information; and
the antenna device according to claim 1 configured to radio-propagate the generated transmission signal.

20. A location identifying system comprising:
the transmitter module according to claim 19;
a receiver module receiving a transmission signal from the transmitter module; and
an identifying section identifying a location of the transmitter module based on the received transmission signal.
